(19) United States
(12) Patent Application Publication
(10) Pub. No.: US 2013/0118837 A1
(43) Pub. Date: May 16, 2013

(54) ELEVATOR INSTALLATION

(71) Applicant: THYSSENKRUPP ELEVATOR AG, Essen (DE)

(72) Inventors: Bernd Altenburger, Neuhausen (DE); Hans-Ferdinand Von Scholley, Wolfschlugen (DE); Holger Zerelles, Leinfelden-Echterdingen (DE)

(73) Assignee: THYSSENKRUPP ELEVATOR AG, Essen (DE)

(21) Appl. No.: 13/706,642

(22) Filed: Dec. 6, 2012

Related U.S. Application Data
(63) Continuation of application No. PCT/EP2011/060347, filed on Jun. 21, 2011.

(30) Foreign Application Priority Data
Jun. 23, 2010 (DE) 10 2010 030 436

(51) Int. Cl. B66B 9/00

(52) U.S. Cl. CPC B66B 9/00
USPC 187/249

(57) ABSTRACT

An elevator installation is provided. The installation includes a shaft in which at least two cars are arranged above one another and are movable vertically separately. Each car has a drive device and a brake device. A safety device is provided for monitoring the cars. At least one travel path limiting device is provided, comprising at least one stop element arranged on at least a first car and an associated retaining element arranged in the shaft. In a stop position, the stop element protrudes laterally from the car and interacts with the associated retaining element. All other cars movable in the shaft may pass this retaining element unobstructed. The brake device or its braking action is deactivatable if the car falls below a limit speed, and the stop and retaining elements may brake the car to a standstill at speeds up to at most the limit speed.

This application is a continuation of international application number PCT/EP2011/060347 filed on Jun. 21, 2011 and claims the benefit of German application number 10 2010 030 436.0 filed on Jun. 23, 2010, which are incorporated herein by reference in their entirety and for all purposes.

### BACKGROUND OF THE INVENTION

The invention relates to an elevator installation with a shaft in which at least two cars are arranged one above the other and are movable vertically up and down separately from each other, each car having a drive device associated therewith for moving the car, and each car having a brake device arranged thereon, and with a safety device for monitoring the operating behavior of the cars, and with at least one travel path limiting device, which comprises at least one stop element arranged on a car and a retaining element arranged in the shaft and interacting with the stop element, for limiting the travel path of the car.

The use of at least two cars which are arranged one above the other in a shaft and can be made to move vertically up and down separately from each other makes it possible to increase the transportation capacity of an elevator installation. Persons and loads can be moved by means of such elevator installations. Associated with each car is a drive device for moving the car vertically up and vertically down. The drive device comprises a drive motor and a drive brake. In order to prevent an unbraked collision of two cars in the event of a malfunction, the elevator installations comprise a safety device with which the operating behavior of the cars can be monitored and, if necessary, an emergency stop triggered. In the case of an emergency stop, the drive motor of the car is switched off and the drive brake is activated. Furthermore, each car has arranged thereon a brake device, for example, a safety gear, with which the car can be mechanically braked if the distance of the car from a neighboring car falls below a safety distance. A travel path limiting device with at least one stop element arranged on the lowest car and with a retaining element arranged at the bottom end of the shaft in the so-called shaft pit is normally also used for the lowest car. With the travel path limiting device, it is possible to limit the travel path of the lowest car and to dampen a collision of the lowest car with elevator installation parts located thereunder or with the shaft pit. Here the retaining element is usually configured in the form of a buffer element which is arranged within the vertical projection of the lowest car in the shaft pit.

As mentioned above, the brake device arranged on the car, in particular, a safety gear, is usually triggered in the event that the distance of the car from a second car located in the direction of travel in front of the car falls below a prescribed safety distance. The safety distance is selected such that after triggering the brake device, the car can be safely braked without colliding with the second car located in front of it. It is thereby possible to reliably prevent a collision. However, the safety distance required to do so, which has to be maintained between two neighboring cars, is often greater than the distance between two immediately adjacent floors of a building in which the elevator installation is installed. This has the consequence that two cars cannot be simultaneously positioned at immediately adjacent stops, which limits the transportation capacity of the elevator installation.

The object of the present invention is to develop an elevator installation of the generic kind in such a way that its transportation capacity can be increased.

### SUMMARY OF THE INVENTION

This object is accomplished, in accordance with the invention, in an elevator installation of the kind stated at the outset in that at least one stop element is arranged on at least a first car, the at least one stop element, in a stop position, protruding laterally from the vertical projection of the first car, and interacting with a certain retaining element associated with this stop element and arranged outside of the vertical projection of all of the cars movable in the shaft, it being possible for all other cars movable in the shaft to pass this retaining element unobstructed, and in that the brake device arranged on the respective car or its braking action is deactivatable if the car falls below a prescribed limit speed, it being possible for the car to be braked to a standstill at speeds up to at most the limit speed by the stop and retaining elements.

In the present case, a vertical projection of a car is understood as a projection of a car in the vertical direction onto a horizontal plane, for example, onto the shaft floor.

In the elevator installation in accordance with the invention, in which at least two cars arranged one above the other and movable separately from each other are used, there is arranged on at least one car a stop element which can assume a stop position in which it protrudes laterally from the vertical projection of the first car. The stop element interacts, in order to limit the travel path of this car, with a certain retaining element which is arranged in the shaft outside of the vertical projection of all of the cars. If the car approaches the associated retaining element at low speed, i.e., at a speed that is less than the prescribed limit speed, the brake device arranged on the car or its braking action can be deactivated and, in the event of a malfunction, the travel path can be limited by the stop element and the associated retaining element. For this purpose, the stop and retaining elements are configured such that they can brake the car to a standstill by the stop element impacting the associated retaining element. To this end, the stop element protrudes laterally from the vertical projection of the car so that it can contact the associated retaining element. The associated retaining element limits only the travel path of this one car, whereas the other cars are not impeded in their travel by this retaining element. The function of the brake device arranged on the car can, therefore, be assumed at low speeds, i.e., at speeds less than the limit speed, by the stop element and the associated retaining element. If a second car is located in the region of the retaining element associated with a first car, then the first car can come very close to the second car at low speed. It is possible to go below the safety distance, which is decisive in triggering the brake device, without the brake device being activated. The brake device or its braking action can be deactivated and, in the event of a failure, the car can be brought to a halt by the stop and retaining elements. The limit speed below which the brake device is deactivated may, for example, be lower than the reduced impact speed of the buffer elements of such elevator installations that is achievable with customary delay control devices of known elevator installations, this reduced impact speed possibly being dependent upon the nominal speed of the elevator installations.

Since the retaining element associated with the stop element of the first car is not arranged within the vertical projection of the first car, but outside of the vertical projection of all of the cars, and only interacts with the stop element of the first car, the travel path of the first car can be limited at any location by suitable positioning of the retaining element associated with this car in the shaft. This retaining element does not impede the other cars.

It may, for example, be provided that the first car is arranged above a second car. If, for example, the second car assumes a position at the lowest stop of the elevator installation, then the first car can move into the stop arranged immediately above it even if the stops are only at a relatively short vertical distance from each other. A collision of the first car with the second car can be reliably prevented, in the event of malfunction of the elevator installation, by the provision of the stop element protruding in the stop position laterally from the vertical projection of the first car and of the retaining element associated with this stop element, without the brake device of the first car having to be activated.

In the embodiment mentioned above, a buffer element arranged below the second car within the vertical projection of the second car can be associated with the second car. A collision of the second car with parts of the elevator installation located thereunder or with the shaft pit can be dampened by the buffer element.

In a corresponding manner, it may be provided that the first car is arranged below a second car and has a stop element protruding laterally from the vertical projection of the first car, which interacts with a certain retaining element arranged in the shaft outside of the vertical projection of all of the cars to prevent a collision of the first car with the second car arranged above it in the event of malfunction of the elevator installation. This makes it possible, for example, to position the second car at a highest stop of the elevator installation, the first car then being able to move into the stop located immediately below it. In the event of malfunction of the elevator installation, a collision of the first car with the second car arranged above it is avoided by the stop element arranged on the first car impacting the retaining element that is associated with this stop element and is arranged outside of the vertical projection of all of the cars in the shaft, without the safety gear of the first car having to be activated.

The limitation of the travel path of at least one car is not limited to an area at the lower or upper end of the shaft. It may also be provided that a retaining element is arranged outside of the vertical projection of all of the cars in the shaft in the area between the shaft pit and the shaft head. The retaining element interacts, in order to limit the travel path of one of the cars, with a certain stop element of a car, which, in a stop position, protrudes outside of the vertical projection of this car. This offers, for example, the possibility of dividing the shaft into an upper and a lower shaft area, with an upper car being movable in the upper shaft area and a lower car being movable in the lower shaft area. The two shaft areas can border directly on each other even if the distances between the stops provided on the individual floors are short. The lowest stop of the upper shaft area can be called at by the upper car and, at the same time, the highest stop of the lower shaft area can be called at by the lower car. A collision of the cars is reliably prevented by the provision of stop elements protruding laterally from the vertical projection of the respective car, which interact with a specific retaining element arranged outside of the vertical projection of all of the cars in the shaft, without the brake devices of the cars being employed.

The elevator installation in accordance with the invention, therefore, makes it possible, even if the distances between the floors are short, to position two cars at stops immediately adjacent to each other, and in the event of malfunction of the elevator installation, a collision of the cars is reliably prevented. The possibility of positioning the cars at stops immediately adjacent to each other results in an increase in the transportation capacity of the elevator installation.

The cars are usually each connected to a counterweight by suspension means. For example, suspension ropes or suspension straps may be used as suspension means. The counterweights execute a counter movement to the respectively associated car when the car moves up or down. To limit the travel path of a car, the movement of its counterweight can also be limited without the movement of the other counterweights being impeded thereby. To this end, there is arranged, in an alternative or supplementary configuration of the invention, on at least one counterweight movable in the shaft at least one stop element, which, in a stop position, protrudes laterally from the vertical projection of the counterweight and interacts with a certain retaining element associated with this stop element and arranged outside of the vertical projection of all of the counterweights, it being possible for all other counterweights movable in the shaft to pass the retaining element unobstructed, and the brake device arranged on the respective car is deactivatable if the car falls below a prescribed limit speed, it being possible for the car to be braked to a standstill at speeds up to at most the limit speed by the stop and retaining elements. Whereas in the configuration of the elevator installation in accordance with the invention explained above, the travel path of a certain car can be limited by the stop element on the car and the associated retaining element in the shaft, in the alternative or supplementary configuration of the elevator installation in accordance with the invention, the travel path of a certain counterweight can be limited without the travel path of the other counterweights being impeded thereby. For this purpose, there is arranged on this counterweight a stop element which, in a stop position, protrudes laterally from the vertical projection of the counterweight and interacts with a retaining element arranged outside of the vertical projection of all of the counterweights in the shaft. If the travel path of a counterweight is limited, unimpeded travel of the associated car is thereby also prevented.

As explained above, in an advantageous embodiment of the invention, the first car, which has a stop element protruding, in the stop position, laterally from its vertical projection, is arranged above a second car.

In a further advantageous embodiment of the invention, the first car is arranged below a second car.

It may be provided that at least one retaining element limits upward travel of the first car. For this purpose, the retaining element is arranged above the stop element protruding, in a stop position, laterally from the vertical projection of the first car.

It may also be provided that at least one retaining element limits downward travel of the first car. For this purpose, the retaining element is positioned below the stop element protruding, in a stop position, laterally from the vertical projection of the first car.

It is particularly advantageous if stop elements are arranged on a first car and on a second car movable directly below the first car, the stop elements, in a stop position, protruding laterally from the vertical projection of the respective car and interacting, in order to limit the travel of the respective car, with a certain retaining element arranged in the shaft, it being possible for the respective other car to pass the retaining element unobstructed.

The first car may, for example, be arranged above the second car, and downward travel of the first car may be limited by the stop element protruding, in a stop position, laterally from the vertical projection of the first car and by the retaining element associated with this stop element. Upward travel of the second car can be limited by the stop element protruding laterally from the vertical projection of the second car and the retaining element associated with this stop element.

In an advantageous configuration of the invention, at least one stop element arranged on a car or on a counterweight is held immovably on the car or on the counterweight. This enables a constructionally particularly simple elevator installation design which can be produced cost-effectively.

It may also be provided that at least one retaining element is held immovably in the shaft.

In a particularly preferred embodiment of the invention, at least one stop element arranged on a car or on a counterweight is movable back and forth relative to the associated retaining element between a release position in which the associated retaining element in the shaft is not contactable, and a stop position in which the associated retaining element is contactable, the brake device arranged on the car or its braking action being deactivatable when the stop element is in the stop position. Depending on the position of the stop element, in such a configuration of the invention, the travel path of the respective car can be limited by the stop element and the associated retaining element without the brake device having to be employed. When the stop element assumes its stop position in which it protrudes from the vertical projection of the car or the counterweight, it can interact with the associated retaining element to limit the travel path by being able to impact the retaining element in the event of malfunction of the elevator installation. If, however, the stop element assumes its release position, then travel of the car or the counterweight is not impeded by the stop element, and, in the event of a failure, the brake device can be used.

The possibility of moving at least one stop element back and forth between a stop position and a release position offers the option of temporarily limiting the travel path of a certain car. This merely requires the stop element to be moved to its stop position. If the temporary limitation of the travel path is to be terminated, the stop element can be moved to its release position again in order to do so.

As an alternative or supplement, it may be provided that at least one retaining element is movable back and forth in the shaft between a retaining position in which it can interact with a certain stop element of a car or of a counterweight, and a release position in which the associated stop element can pass the retaining element unobstructed, the brake device arranged on the car or its braking action being deactivatable when the retaining element is in the retaining position. Depending on which position the retaining element arranged in the shaft is assuming, the travel path of a certain car or of a counterweight can, therefore, be temporarily limited.

The stop element can be movably mounted on the car by, for example, the stop element being held pivotably or displaceably on the associated car or on the associated counterweight.

The retaining element can be movably mounted in the shaft by, for example, the retaining element being pivotably or displaceably mounted.

In a preferred configuration of the invention, at least one retaining element is held on a shaft wall, a guide rail of a car or of a counterweight or on a shaft floor or a shaft ceiling. It may also be provided that at least one retaining element is held on several of the aforementioned components.

The brake device arranged on each car is preferably triggerable in dependence upon the speed of the car and/or of the distance the car assumes from an obstacle. For example, it may be provided that the brake device is triggerable independently of a distance from an obstacle if the speed of the car exceeds a maximum speed. In addition, triggering may occur if a distance falls below a safety distance which preferably depends on the speed of the car.

The brake device arranged on each car is advantageously configured as a safety gear.

It is advantageous if at least one retaining element and/or at least one stop element comprises a buffer element which dampens an impact. The buffer element dampens the impact by absorbing at least part of the impact energy.

The buffer element may, for example, be configured as a hydraulic buffer or as an elastomer buffer.

Advantageously, the buffer element is plastically and/or elastically deformable.

It may be provided that the buffer element is designed only for impact speeds lower than the nominal speed of the cars of the elevator installation. This enables the size of the buffer element to be kept small. As explained above, a collision of two cars can be prevented by the interacting stop and retaining elements, for example, in the event that the cars call at stops of the elevator installation immediately adjacent to each other. In this state, the cars are no longer traveling at their nominal speed, but at a significantly reduced speed, otherwise the safety device of the elevator installation would already respond as they approach the stop. If the stop or retaining elements have a buffer element, it is, therefore, not absolutely necessary to design the buffer element for the nominal speeds of the cars.

It may, for example, be provided that the buffer element is designed for impact speeds lower than 5 m/s, in particular, for impact speeds of at most 3 m/s or at most 2 m/s. For example, the buffer element may be designed for impact speeds of 1 m/s. It may be provided that the buffer element is designed for impact speeds lower than the reduced impact speed of the buffer elements that is achievable with customary delay control devices of known elevator installations, this reduced impact speed possibly being dependent upon the nominal speed of the elevator installations. The design of the buffer element determines the impact energy that can be absorbed by the buffer element. The higher the impact speed, the greater is the impact energy. The absorption of a smaller amount of impact energy will also require only a smaller space for the buffer element.

The buffer element is preferably designed for impact speeds up to at most the limit speed. As explained above, the brake device arranged on the car or its braking action can be deactivated if the speed of the car falls below the limit speed. The function of the brake device can then be assumed by the buffer element.

The following description of preferred embodiments of the invention serves for further explanation in conjunction with the drawings.

### BRIEF DESCRIPTION OF THE DRAWINGS

FIG. 1 shows a schematic representation of a first embodiment of an elevator installation in accordance with the invention;

FIG. 2 shows a sectional view taken along line 2-2 in FIG. 1;

FIG. 3 shows a schematic representation of a second embodiment of an elevator installation in accordance with the invention;

FIG. 4 shows a schematic representation of a third embodiment of an elevator installation in accordance with the invention;

FIG. 5 shows a sectional view taken along line 5-5 in FIG. 4; and

FIG. 6 shows a schematic representation of a fourth embodiment of an elevator installation in accordance with the invention.

### DETAILED DESCRIPTION OF THE INVENTION

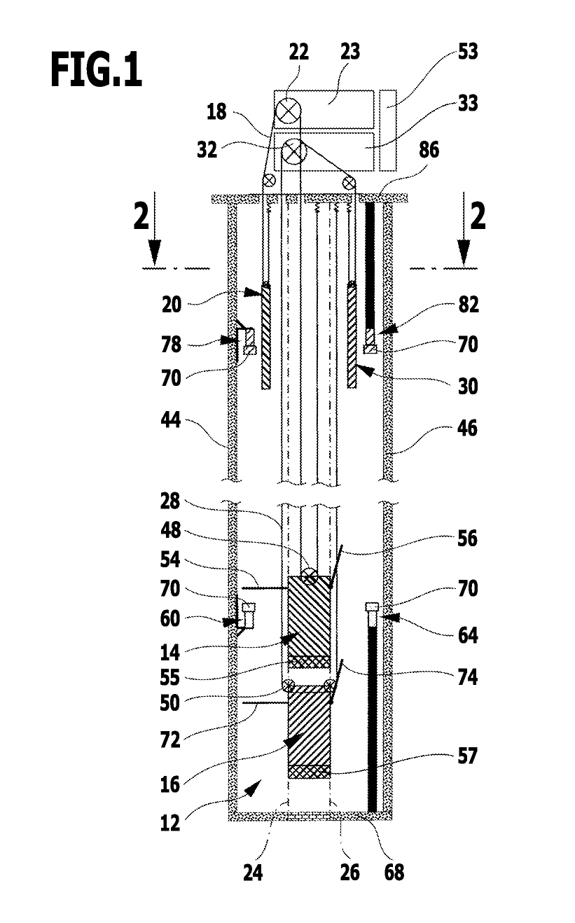

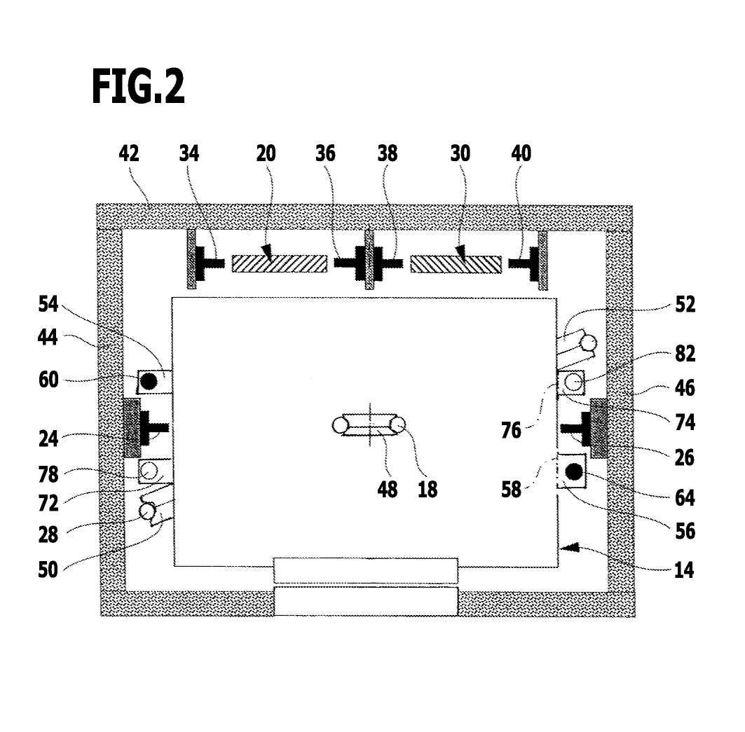

FIGS. 1 and 2 show schematically an elevator installation, generally denoted by reference numeral 10, with a shaft 12 in which a first car 14 and a second car 16 are arranged one above the other and can be made to move vertically up and down separately from each other. The first car 14 is connected by suspension means in the form of a first suspension rope 18 to a first counterweight 20. The first suspension rope 18 is led over a first traction sheave 22, which can be made to rotate by a first drive device 23. The first drive device 23 comprises in a manner known per se a drive motor and a drive brake (not shown in the drawings). The first car 14 can be made to move vertically up and down along vertical guide rails 24, 26 in the shaft 12 by means of the first traction sheave 22.

The second car 16 is connected by second suspension means in the form of a second suspension rope 28 to a second counterweight 30. The second suspension rope 28 is led over a second traction sheave 32, which can be made to rotate by a second drive device 33. The second drive device comprises in a manner known per se a drive motor and a drive brake. The second car 16 can be made to move vertically up and down along the guide rails 24, 26 in the shaft 12 separately from the first car 14 by means of the second traction sheave 32.

To simplify and facilitate understanding of the representation, the two counterweights 20 and 30 are shown on opposite sides of the cars 14 and 16 in FIG. 1. This is merely for ease of comprehension. In actual fact, in the elevator installation 10, the counterweights 20 and 30, as shown in FIG. 2, are held by means of guide rails 34, 36 and 38, 40, respectively, on a shaft rear wall 42 so as to be movable in the vertical direction. The two counterweights 20, 30 are, therefore, movable alongside each other. Such an arrangement is, however, not absolutely necessary. The counterweights 20 and 30 could also be arranged on different sides of the cars 14 and 16 or else both on one shaft side wall. It is also possible to arrange the counterweights 20, 30 so that they are movable one above the other.

The guide rails 24, 26 along which the first car 14 and the second car 16 can be made to move are secured to opposite shaft side walls 44, 46. This will also be clear from FIG. 2. The guide rails 24, 26 may, however, also be attached to the shaft rear wall 42.

In the elevator installation 10 shown, the first suspension rope 18 is coupled to the first car 14 by means of a central deflection pulley 48 held freely rotatably on the roof of the first car 14, and the second suspension rope 28 is coupled to the second car 16 by means of two lateral deflection pulleys 50, 52 arranged on sides that face away from each other on the roof of the second car 16. This will be clear, in particular, from FIG. 2. The first car 14 is arranged above the second car 16. Alternatively, the first suspension rope 18 could also be coupled to the first car 14 by means of a rope end attachment to the roof of the first car 14. One skilled in the art is familiar with such rope end attachments.

To monitor the operating behavior of the two cars, the elevator installation 10 comprises an electronic safety device 53, which is coupled to the drive devices 23 and 33 and also to distance and speed sensors which are known per se and are, therefore, not shown in the drawings. The distance and speed sensors are arranged on the cars 14, 16 and/or on other movable elevator components and/or in the shaft 12. If the operating behavior of a car 14, 16 is not in accordance with an admissible operating behavior, an emergency stop of the car concerned can be triggered by the safety device. To this end, the drive motor of the car 14, 16 is switched off and the drive brake is activated.

Each car 14, 16 carries a brake device 55 and 57, respectively, which in the embodiment shown is configured as a safety gear. The respective car 14, 16 can be mechanically braked within a very short time by the brake device 55 and 57, respectively, if the speed of the car 14, 16 exceeds a prescribed maximum speed or the distance of the car 14, 16 from an obstacle, in particular, a neighboring car, falls below a prescribed safety distance.

At sides that face away from each other, the first car 14 carries a first stop element 54 and a second stop element 56 associated with a shaft side wall 44 and 46, respectively. The first stop element 54 is immovably fixed to the first car 14 and protrudes laterally in the direction of the shaft side wall 44 from the vertical projection of the first car 14. The second stop element 56 is held movably on the first car 14; in the embodiment shown, it is pivotable about a first pivot axis 58 between a release position facing upwards at an incline, shown in FIG. 1, and a horizontally oriented stop position, shown in FIG. 2.

Associated with the first stop element 54 is a first retaining element 60 which is arranged in the shaft 12 outside of the vertical projection of the two cars 14, 16 and, in the embodiment shown, is attached to the shaft side wall 44.

Associated with the second stop element 56 is a second retaining element 64 which is arranged in the shaft 12 outside of the vertical projection of all of the cars 14, 16 and, in the embodiment shown, is attached to the shaft floor 68 of the shaft 12.

The first retaining element 60 and also the second retaining element 64 comprise a buffer element 70, which is fixed in the shaft 12 outside of the projection of all of the cars 14, 16. The buffer element 70 may, for example, be configured in the form of a hydraulic buffer or else in the form of an elastomer buffer.

When a lower end position of the first car 14 is reached during downward travel, the first stop element 54 strikes the first retaining element 60 and thereby limits the travel path of the first car 14 vertically downwards.

In a corresponding manner, the second stop element 56, provided it assumes its horizontally oriented stop position, strikes the second retaining element 64 when a lower end position of the first car 14 is reached during downward travel of the first car 14, and thereby also limits the travel path of the first car 14 vertically downwards.

Associated with the second car 16 is a third stop element 72, which is immovably fixed to the second car 16 and protrudes laterally from the vertical projection of the second car 16. The third stop element 72 faces the shaft side wall 44. This will be clear, in particular, from FIG. 2. Furthermore, a fourth stop element 74 is held movably on the second car 16. In the embodiment shown, the fourth stop element 74 is movable back and forth about a second pivot axis 76 between a release position oriented upwardly at an incline, shown in FIG. 1, and a horizontally oriented stop position, shown in FIG. 2.

Associated with the third stop element 72 is a third retaining element 78, which is arranged in the shaft 12 outside of the vertical projection of all of the cars 14, 16. In the embodiment shown, the third retaining element 78 is fixed to the shaft side wall 44.

Associated with the fourth stop element 74 is a fourth retaining element 82, which is arranged in the shaft 12 outside of the vertical projection of all of the cars 14, 16 and is held on the shaft ceiling 86 of the shaft 12.

During upward travel of the second car 16, when an upper end position of the second car 16 is reached, the third stop element 72 strikes the third retaining element 78. The travel path of the second car 16 is thereby limited vertically upwards.

In a corresponding manner, the fourth stop element 74, provided it assumes its horizontally oriented stop position, strikes the fourth retaining element 82 when an upper end position of the second car 16 is reached during upward travel of the second car 16, and the travel path of the second car 16 is thereby also limited vertically upwards.

The third retaining element 78 and also the fourth retaining element 82 comprise a buffer element 70, which absorbs at least part of the impact energy and thereby dampens the impact when the stop elements 72, 74 strike the retaining elements 78, 82.

As explained above, the retaining elements 60, 64, 78 and 82 are arranged outside of the vertical projection of the cars 14 and 16 and, of course, also outside of the vertical projection of the counterweights 20 and 30. The retaining elements 60, 64, 78 and 82 each interact only with a specific stop element of the cars 14 and 16, respectively, provided this stop element assumes its stop position. The interaction occurs in such a way that, in each case, a certain stop element can strike a certain retaining element provided the stop element assumes its stop position in which it protrudes laterally from the vertical projection of the respective car 14 and 16, respectively. This makes it possible to specifically limit the travel path of a certain car 14 and 16, respectively, by means of at least one stop element and a retaining element associated with this stop element.

If, as illustrated by the second stop element 56 and the fourth stop element 74 in the embodiment shown, only movable stop elements are used, the travel path of the respective car 14 and 16, respectively, can be temporarily reduced by the respective stop element 56 and 74, respectively, being pivoted into its stop position in which it can interact, in each case, with a certain retaining element 64 and 82, respectively, to limit the travel path. If the travel path is not to be limited, the respective stop element 56 and 74, respectively, can be pivoted into its release position shown in FIG. 1, in which it cannot interact with any of the retaining elements arranged in the shaft. As an alternative or supplement, the retaining elements could also be movably mounted so that in a retaining position in cooperation with the respectively associated stop element they can temporarily limit the travel path of a car, whereas in a release position they do not limit the travel path.

If the speed of the car 14, 16 is less than a prescribed limit speed, the brake device 55 and 57, respectively, arranged on the respective car 14, 16 or its braking action is deactivated. Provision of the first stop element 54 and the second stop element 56 and of the retaining elements 60 and 64, respectively, associated with these stop elements in combination with the speed-dependent deactivation of the brake devices 55, 57 makes it possible to position the first car 14 at a stop which is immediately adjacent to a lowest stop of the elevator installation 10, the second car 16 being positioned at the lowest stop, and the distance between the cars 14 and 16 being less than the safety distance. The first car 14 can come very near to the second car 16 at a speed which is less than the prescribed limit speed without the brake device 55 being triggered by the distance being less than the safety distance. Rather, in the event of malfunction of the elevator installation 10, provision of the stop and retaining elements 54, 56 and 60, 64 ensures that the first car 14 cannot collide with the second car 16 located below it. Before a collision occurs, the stop elements 54 and 56 strike the retaining elements 60 and 64 and thereby block further downward movement of the first car 14.

In a corresponding manner, the stop elements 72 and 74 arranged on the second car 16 in combination with the retaining elements 78 and 82, respectively, associated with these stop elements ensure that the second car 16 can assume a position at a stop which is immediately adjacent to a highest stop of the elevator installation 10, the first car 14 being located at the highest stop. The second car 16 can come very near to the first car 14 at a speed which is less than the prescribed limit speed without the brake device 57 being triggered by the distance being less than the safety distance. A collision of the second car 16 with the first car 14 is reliably prevented by the stop elements 72, 74 in combination with the retaining elements 78 and 82.

In the event of impact of the stop elements 54, 56, 72, 74 on the associated retaining elements 60, 64 and 78, 82, respectively, in order to be able to absorb the kinetic energy of the cars 14, 16 and to brake the cars 14, 16 to a standstill, the buffers 70 of the retaining elements 60, 64, 78, 82 are designed for a maximum impact speed which corresponds to the prescribed limit speed. This may, for example, be 3 m/s or 2 m/s or only 1 m/s. The necessary buffer path can, therefore, be kept relatively low. If the speed of a car 14, 16 falls below the limit speed when approaching the associated retaining elements, the brake device 55 and 57, respectively, can be deactivated and the car 14, 16, in the event of malfunction, be reliably brought to a halt by the buffer elements 70.

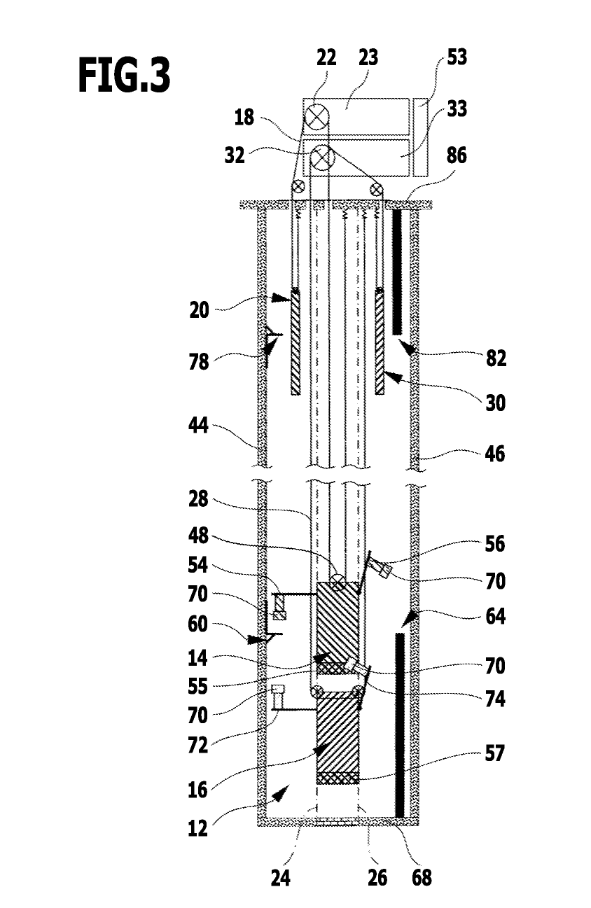

A second embodiment of an elevator installation in accordance with the invention, generally denoted by reference numeral 100, is shown in FIG. 3. This is largely identical in configuration to the elevator installation 10 explained above with reference to FIGS. 1 and 2. The same reference numerals as in FIGS. 1 and 2 are, therefore, used for identical components in FIG. 3, and regarding these components reference is made to the above explanations in order to avoid repetitions.

The elevator installation 100 differs from the elevator installation 10 in that the buffer elements 70 are not arranged on the retaining elements 60, 64, 78 and 82, but instead the buffer elements 70, in the elevator installation 100 shown in FIG. 3, are held on the stop elements 54, 56 and 72, 74. Again, when the stop elements 54, 56 strike the retaining elements 60 and 64, respectively, and when the stop elements 72 and 74 strike the retaining elements 78 and 82, the impact energy can be absorbed by the buffer elements 70 after the brake devices 55, 57 have been deactivated upon slow approach to the retaining elements 60, 64, 78, 82.

In the elevator installation 100, the travel path of the cars 14 and 16 can also be temporarily reduced by use of only the movable stop elements 56 and 74 by these stop elements 56, 74 being pivoted into their horizontally oriented stop position. If a temporary reduction in the travel path is not required, the stop elements 56, 74 can be pivoted into their release position.

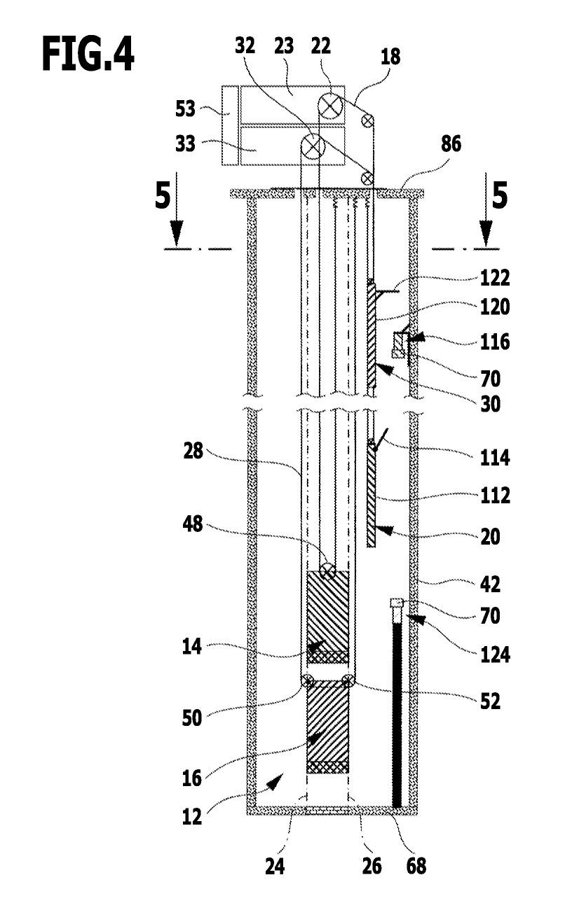

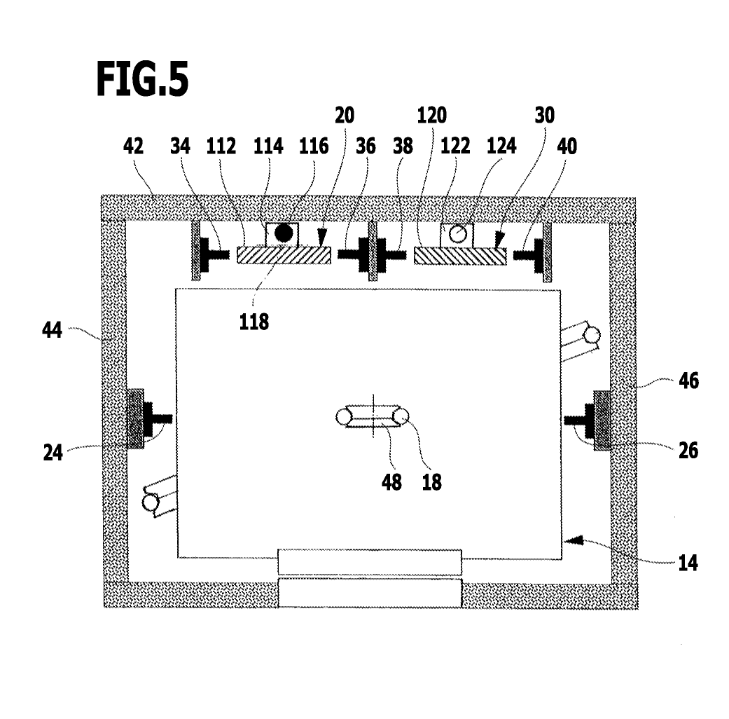

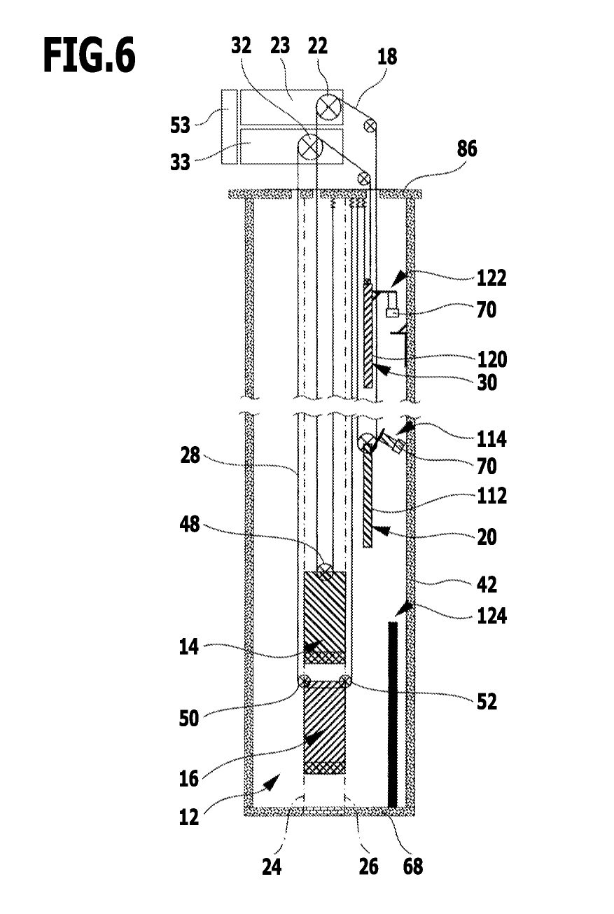

A third embodiment of an elevator installation 110 in accordance with the invention, which is largely identical in construction to the elevator installations 10 and 100 explained above, is shown in FIGS. 4 and 5. Identical reference numerals will, therefore, be used for identical components in the elevator installation 110 shown in FIGS. 4 and 5 and also in the elevator installation 130 shown in FIG. 6 and explained below, as in FIGS. 1, 2 and 3, and regarding these components reference is made to the above explanations in order to avoid repetitions.

The elevator installations 110 and 130 are shown in FIGS. 4 and 6 in sectional views, which run perpendicularly to the shaft rear wall 42 and thereby make the arrangement of the counterweights 20, 30 alongside each other and the region between the counterweights 20, 30 and the shaft rear wall 42 clearer. In the elevator installations 110 and 130, differently from the elevator installations 10 and 100 explained above, stop elements are not arranged on the cars 14, 16 but on the respective counterweights 20 and 30, respectively. These stop elements also each interact with a certain retaining element arranged in the shaft 12 in order to limit the travel path of the respective counterweight 20 and 30, respectively, and, therefore, also the travel path of the respectively associated car 14 and 16, respectively.

As will be clear from FIG. 4, a fifth stop element 114 is held on the rear side 112 of the first counterweight 20 that faces the shaft rear wall 42. The fifth stop element 114 protrudes laterally from the vertical projection of the first counterweight 20 and during downward travel of the first car 14, i.e., upon movement of the first counterweight 20 vertically upwards, when a lower end position of the first car 14 is reached, interacts with a fifth retaining element 116 which is fixed to the shaft rear wall 42 and has a buffer element 70, which has already been explained above with reference to FIGS. 1, 2 and 3.

The fifth stop element 114 is movably held on the first counterweight 20 and can be moved back and forth between a release position shown in FIG. 4, which is oriented upwards at an incline, and a stop position shown in FIG. 5, which is horizontally oriented and faces the shaft rear wall 42. In the embodiment shown, the fifth stop element 114 is mounted on the first counterweight 20 for pivotal movement about a third pivot axis 118. The fifth stop element 114 can be pivoted into its stop position for temporary limitation of the travel path of the first counterweight 20 and, therefore, also for temporary limitation of the travel path of the first car 14. If the travel path of the first counterweight 20 and, therefore, also the travel path of the first car 14 are not to be limited, the fifth stop element 114 can assume its release position.

If the speed of the first car 14 is less than the limit speed, the brake device 55 can be deactivated. If the second car 16 is located at the lowest stop of the elevator installation 110, the first car 14 can approach the second car at low speed, i.e., a speed which is less than the limit speed, without the brake device 55 being triggered. In the event of malfunction of the elevator installation 110, the first car 14 is braked by the fifth stop element 114 impacting the buffer 70 of the fifth retaining element 116. This limits the travel path of the counterweight 20 and, therefore, also the travel path of the first car 14.

The second counterweight 30 of the elevator installation 110 shown in FIG. 4 carries on its rear side 120 that faces the shaft rear wall 42 a sixth stop element 122, which during upward travel of the second car 16, i.e., during movement of the second counterweight 30 vertically downwards, when an upper end position of the second car 16 is reached, interacts with a sixth retaining element 124 which is fixed to the shaft floor 68 of the elevator installation 110 and has a buffer element 70. During upward travel of the second car 16, the sixth stop element 122, when an end position prescribed by the positioning of the sixth retaining element 124 is reached, strikes the buffer element 70 of the sixth retaining element 124 and thereby limits the travel path of the second counterweight 30 and, therefore, also the travel path of the second car 16.

If the speed of the second car 16 is less than the limit speed, the brake device 57 can be deactivated. If the first car 14 is located at the highest stop of the elevator installation 110, the second car 16 can approach the first car 14 at a speed which is less than the limit speed without the brake device 57 being triggered. In the event of malfunction of the elevator installation 110, the second car 16 is braked by the sixth stop element 122 impacting the buffer 70 of the sixth retaining element 124. This limits the travel path of the counterweight 30 and, therefore, also the travel path of the second car 16.

The sixth stop element 122 interacts only with the sixth retaining element 124 so that specifically the travel path of the second counterweight 30 and, therefore, also specifically the travel path of the second car 16 can be limited by these two components. In a corresponding manner, the fifth stop element 114 interacts only with the fifth retaining element 116 so that only the travel path of the first counterweight 20 and, therefore, also the travel path of the first car 14 can be limited by these two components.

The elevator installation 130 shown in FIG. 6 is largely identical in construction to the elevator installation 110 shown in FIG. 4. The elevator installation 130 differs from the elevator installation 110 only in that the buffer elements 70 are not arranged on the fifth and sixth retaining elements 116 and 124, respectively, but on the respectively associated stop elements 114 and 122. In the case of the elevator installation 130, the travel paths of the counterweights and cars can also be limited by the stop elements arranged on the counterweights and the retaining elements respectively associated with these. Here the stop elements protrude laterally from the vertical projection of the counterweights, and the retaining elements are positioned outside of the vertical projection of all of the counterweights in the shaft 12.

1. Elevator installation comprising:
a shaft in which at least two cars are arranged one above the other and are movable vertically up and down separately from each other, each car having a drive device associated therewith for moving the car, and each car having a brake device arranged thereon; and
a safety device for monitoring the operating behavior of the cars; and
at least one travel path limiting device, which comprises at least one stop element arranged on a car and a retaining element arranged in the shaft and interacting with the stop element, for limiting the travel path of the car;
wherein at least one stop element is arranged on at least a first car, the at least one stop element, in a stop position, protruding laterally from the vertical projection of the first car, and interacting with a certain retaining element associated with this stop element and arranged outside of the vertical projection of all of the cars, it being possible for all other cars movable in the shaft to pass the retaining element unobstructed; and
wherein the brake device arranged on the respective car or its braking action is deactivatable if the car falls below a prescribed limit speed, it being possible for the car to be braked to a standstill at speeds up to at most the limit speed by the stop and retaining elements.

2. Elevator installation comprising:
a shaft in which at least two cars are arranged one above the other and are movable vertically up and down separately from each other, each car having a drive device associated therewith for moving the car, and each car having a brake device arranged thereon; and
a safety device for monitoring the operating behavior of the cars; and
at least one travel path limiting device, which comprises at least one stop element arranged on a car and a retaining element arranged in the shaft and interacting with the stop element, for limiting the travel path of the car;
wherein each car is connected by suspension means to a counterweight movable in the shaft;
wherein at least one stop element is arranged on at least one counterweight, the at least one stop element, in a stop position, protruding laterally from the vertical projection of the counterweight and interacting with a certain retaining element associated with this stop element and arranged outside of the vertical projection of all of the counterweights, it being possible for all other counterweights movable in the shaft to pass the retaining element unobstructed; and
wherein the brake device arranged on the respective car is deactivatable if the car falls below a prescribed limit speed, it being possible for the car to be braked to a standstill at speeds up to at most the limit speed by the stop and retaining elements.

3. Elevator installation in accordance with claim 1, wherein the first car is arranged above a second car.

4. Elevator installation in accordance with claim 1, wherein the first car is arranged below a second car.

5. Elevator installation in accordance with claim 1, wherein at least one retaining element limits downward travel of the first car.

6. Elevator installation in accordance with claim 1, wherein at least one retaining element limits upward travel of the first car.

7. Elevator installation in accordance with claim 1, wherein stop elements are arranged on the first car and on a second car movable directly below the first car, the stop elements, in a stop position, protruding laterally from the vertical projection of the respective car and interacting, in order to limit the travel of the respective car, with a certain retaining element arranged in the shaft, it being possible for the respective other car to pass the retaining element unobstructed.

8. Elevator installation in accordance with claim 1, wherein at least one stop element arranged on the car or on the counterweight is held immovably.

9. Elevator installation in accordance with claim 1, wherein at least one retaining element is held immovably in the shaft.

10. Elevator installation in accordance with claim 1, wherein at least one stop element arranged on the car or on the counterweight is movable back and forth relative to the associated retaining element between a release position in which the respectively associated retaining element is not contactable, and a stop position in which the respectively associated retaining element is contactable, the brake device arranged on the car or its braking action being deactivatable when the stop element is in the stop position.

11. Elevator installation in accordance with claim 1, wherein at least one retaining element is movable back and forth in the shaft between a retaining position in which it can interact with a certain stop element of a car or of a counterweight, and a release position in which the associated stop element can pass the retaining element unobstructed, the brake device arranged on the car or its braking action being deactivatable when the retaining element is in the retaining position.

12. Elevator installation in accordance with claim 1, wherein at least one retaining element is held on a shaft wall, a guide rail, a shaft floor, a shaft ceiling or on several of these components.

13. Elevator installation in accordance with claim 1, wherein at least one of at least one retaining element and at least one stop element comprises a buffer element which dampens an impact.

14. Elevator installation in accordance with claim 13, wherein the buffer element is configured as a hydraulic buffer or an elastomer buffer.

15. Elevator installation in accordance with claim 13, wherein the buffer element is at least one of plastically and elastically deformable.

16. Elevator installation in accordance with claim 13, wherein the buffer element is designed for impact speeds lower than the nominal speed of the cars of the elevator installation.

17. Elevator installation in accordance with claim 13, wherein the buffer element is designed for impact speeds up to at most the limit speed.

18. Elevator installation in accordance with claim 1, wherein the brake device arranged on each car is triggerable in dependence upon at least one of the speed of the car and the distance of the car from an obstacle.

19. Elevator installation in accordance with claim 1, wherein the brake device arranged on each car is configured as a safety gear.
